(19) United States
(12) Patent Application Publication
(10) Pub. No.: US 2025/0124541 A1
(43) Pub. Date: Apr. 17, 2025

(54) Method and Apparatus for Image Rectification and Stitching

(71) Applicant: Alltec Angewandte Laserlicht Technologie GmbH, Selmsdorf (DE)

(72) Inventors: Laura Beutel, Alsbach-Hähnlein (DE); Markus Jehle, Alsbach-Hähnlein (DE)

(21) Appl. No.: 18/688,020

(22) PCT Filed: Aug. 31, 2022
(86) PCT No.: PCT/EP2022/074221

§ 371 Date: Feb. 29, 2024

(30) Foreign Application Priority Data
Sep. 3, 2021 (GB) 2112597.6

(51) Int. Cl. G06T 3/4038; G06T 7/62; G06T 7/73; G06V 10/24

(52) U.S. Cl. CPC G06T 3/4038; G06T 7/62; G06T 7/73; G06V 10/245; G06T 2207/10028

(57) ABSTRACT

There is provided a computed implemented method for stitching together a plurality of images, each image comprising a scene containing an object comprising a mark. The method comprises, obtaining intrinsic calibration parameters for one or more cameras, obtaining a first image captured by one of the one or more cameras, the first image containing the object and at least a first portion of a mark, obtaining a second image captured by one of the one or more cameras, the second image containing the object and at least a second portion of the mark, wherein the at least first and second portions of the mark partially overlap and obtaining data indicative of a length associated with the object. For each image, the method further comprises determining data indicative of a position of the object within the image in 2D image coordinates, determining data indicative of a position of the object in camera coordinates based on the data indicative of the position of the object within the image in 2D image coordinates and the data indicative of the length associated with the object, determining a transformation matrix based on the data indicative of the position of the object in camera coordinates, obtaining a 3D point cloud of a virtual object, said virtual object associated with the object, transforming the 3D point cloud of the virtual object using the transformation matrix to obtain a second 3D point cloud, projecting the second 3D point cloud into 2D image coordinates using the intrinsic calibration parameters to obtain a projected point grid, rectifying a portion of the image using the projected point grid to obtain a rectified image, stitching the first rectified image and the second rectified image to obtain a stitched image comprising a combined mark, the combined mark comprising the at least first and second portions of the mark.

### TECHNICAL FIELD

The present disclosure relates to methods of image rectification and stitching suitable for inspecting marks contained in a plurality of images.

### BACKGROUND

During the production, packaging and/or transportation of bottles of medicament, marks are applied to the bottles. The marks typically contain information about the medicament contained within the bottle. The mark is usually printed onto a label and the label is then applied to the bottle. Although in some cases, the mark is printed directly onto the bottle.

Bottles are typically cylindrical, having a top, a base and a generally cylindrical wall. Labels (or marks) are typically applied to the cylindrical wall, meaning that it can be difficult to inspect the mark (e.g. to determine print quality issues or simply to read the information for further processing) from a single image of the bottle, due to the curvature of the bottle. It is therefore beneficial to capture multiple images of the bottle at different orientations, and stitch the images together so as to obtain a single image comprising the label. However, such processes require complex calibration methods. For example, extrinsic calibration, which defines the relationship between different cameras to each other, may be required in combination with intrinsic calibration of the cameras to determine the position and orientation of a bottle in images taken by the cameras. Extrinsic calibration is typically carried out at the user's location (e.g. a production or packaging facility), where all cameras are located in their desired positions relative to each other, and relative to the bottle to be imaged, prior to extrinsic calibration. However, the user is typically not an expert in camera calibration, meaning that mistakes in the extrinsic calibration process can occur leading to poor stitching results when in use. Additionally, such processes are not robust to changes in the dimensions of the bottle, or of the position of the bottle when the images are captured, e.g. where a bottle's position deviates from a position for which the cameras have been calibrated. This can lead to errors in the stitching process, which can then lead to errors when reading the label.

An alternative method is to use a calibration object with the same shape and size as the bottles to be images. The calibration object is imaged while located at the exact position as the bottle will be imaged from during use. The calibration object has dots (e.g. calibration marks) on its surface arranged in predetermined manner, e.g. providing a regular grid. A mapping rule can be created to map the captured dots in an image back into the regular grid. The mapping therefore can rectify the image. This method does not require extrinsic or intrinsic calibration. However, this method does require precise arrangement of the calibration object and camera in order to obtain accurate results. As with extrinsic calibration, such methods typically need to be carried out at the user's location, where mistakes can easily occur. Furthermore, this method is not robust to changes in the dimensions of the bottle, or of the position of the bottle when the images are captured.

It is important that the mark (e.g. printed information) on the bottle can be read clearly. That is, it is important that the print of the mark is of a sufficient quality such that it can be read clearly (either by a human or by a machine). Sometimes, a mark may be applied in a way that leads to the mark having a poor quality, e.g. the mark is difficult to read or is missing information. Poor quality can be caused by a number of reasons. For example, a print head used to print a mark on a label may be faulty, and so may not deposit ink on the label in the correct way; a printer may have run out of a component of ink, causing only a portion of the ink to be deposited; a print head may be incorrectly aligned with a label during printing, etc.

It is therefore important to check the quality of the mark following application of the mark to the bottle. This is particularly important in certain industries, such as the pharmaceutical industry, where the information contained in the mark may be vital. For example, the mark may comprise a dose of medicament contained within the bottle. Clearly, if the dose cannot be read, or is read incorrectly, this can have profound effects on an end user.

It is an object of the present disclosure to address one or more of the aforementioned problems.

### SUMMARY

In a first aspect of the invention, there is provided a computed implemented method for stitching together a plurality of images, each image comprising a scene containing an object comprising a mark. The method comprises, obtaining intrinsic calibration parameters for one or more cameras, obtaining a first image captured by one of the one or more cameras, the first image containing the object and at least a first portion of a mark, obtaining a second image captured by one of the one or more cameras, the second image containing the object and at least a second portion of the mark, wherein the at least first and second portions of the mark partially overlap and obtaining data indicative of a length associated with the object. For each image, the method further comprises determining data indicative of a position of the object within the image in 2D image coordinates, determining data indicative of a position of the object in camera coordinates based on the data indicative of the position of the object within the image in 2D image coordinates and the data indicative of the length associated with the object, determining a transformation matrix based on the data indicative of the position of the object in camera coordinates, obtaining a 3D point cloud of a virtual object, said virtual object associated with the object, transforming the 3D point cloud of the virtual object using the transformation matrix to obtain a second 3D point cloud, projecting the second 3D point cloud into 2D image coordinates using the intrinsic calibration parameters to obtain a projected point grid, rectifying a portion of the image using the projected point grid to obtain a rectified image, stitching the first rectified image and the second rectified image to obtain a stitched image comprising a combined mark, the combined mark comprising the at least first and second portions of the mark.

Advantageously, the method of the first aspect provides a way in which multiple images can be accurately stitched together without requiring complex calibration techniques, such as extrinsic calibration, of cameras used to capture the images. That is, the location of the cameras relative to each other and to the object does not need to be provided. Given that extrinsic calibration does not need to be carried out, the cameras can be intrinsically calibrated individually and prior to installation in, for example, a bottle detection device. As such, no calibration is required at the user's site (e.g. a production, printing or packaging facility). Additionally, it has been found the method is very tolerant in terms of deviations of the object's physical dimensions with respect to other solutions that require complex calibration such as extrinsic calibration. For example, no further calibration is required to be used for products with different physical dimensions (such as different radii) as is the case with solutions that require complex calibration such as extrinsic calibration. Furthermore, it has been found that the present method is more robust to changes in the position of the object in the image relative to the camera. For example, objects travelling along a conveyor may not always be in the same position when they are imaged. It has also been found that the present method is more robust to deviations in the symmetry of the object, over existing methods. This is particularly important where the object is a bottle, as bottles typically comprise two identical parts that are glued together to form a cylinder.

However, due to manufacturing tolerances, the bottle is not always symmetrical when the two parts have been glued together.

The virtual object may be a virtual representation of the object. For example, the virtual object's shape may correspond with the object's shape. In the case where the object is a cylindrical bottle, the virtual object may be a cylinder.

The 3D point cloud may be calculated when required, or may be accessed from a database.

The portion of the image may comprise the portion of the mark. That is, it may not be necessary to rectify the entire image, but only the portion of the image containing the mark.

The intrinsic calibration parameters may comprise data indicative of any one of focal length, the principal point (or optical centre), the pixel size and lens distortion.

The data indicative of a length associated with the object may be data indicative of a physical dimension of an object. For example, said data may comprise data indicative of the radius of the object. For example, the radius may be provided by a user or measured using a sensor. Alternatively, the data indicative of a length associated with the object may be data indicative of a distance. For example, said distance may be a distance between a camera that captured an image of the object, and the object. The distance may be the distance at the time the image was captured. The distance may be obtained using any suitable means. For example, a user may provide the distance. For example, the user may have knowledge as to where the objects will be when the images are captured, and may also have knowledge as to where the cameras are.

The first and second images may be captured by first and second cameras. Alternatively, both the first and second images may be captured by the same camera. For example, a single camera may be rotated about an object to capture two or more images. Alternatively, the object may be rotated about its axis such that a single camera can capture the first and second images.

Obtaining data indicative of the length of the object may comprise one of obtaining data indicative of a physical dimension of the object or obtaining data indicative of a distance of the object from one of the one or more cameras.

Obtaining data indicative of the physical dimension of the object may comprise obtaining data indicative of a radius of the object.

The object may be cylindrical, or generally cylindrical, such as a bottle, and the radius may be a radius of the cylinder.

Obtaining the first image may comprise capturing the first image with one of the one or more cameras and obtaining the second image may comprise capturing the second image with one of the one or more cameras.

The cameras may be any suitable cameras. The cameras may be area scan cameras. The cameras may be configured to capture light in the visible spectrum, and/or may also be configured to capture light in the infra-red spectrum or ultraviolet spectrum.

Capturing the first image may comprise arranging one of the one or more cameras to capture the image from a first angle. Capturing the second image may comprise arranging one of the one or more cameras to capture the image from a second angle, the first angle different from the second angle.

The images may be captured from a common plane. For example, where two cameras are used, the cameras may be located generally in a common plane, such as located at the same or similar height, but may image the object at different angles so as to image different sides of the object from within the common plane. The arrangement of the first and second cameras may be such that an approximately 180 degree view of the object is obtained. For example, each of the cameras may be located at relative azimuth angles, 0 degrees and 90 degrees.

Where two cameras are used, capturing the first and second image may be done simultaneously.

Determining data indicative of a position of the object within the image in 2D image coordinates may comprise determining a position of one or more outer edges of the object.

The outer edges may correspond with the sides of the object. For example, in the case where the object is a cylindrical bottle, the outer edges may correspond to the circumferential wall of the bottle.

Determining the outer edges may be based on determining a significant contrast difference indicative of the outer edges of the object in the image.

Determining data indicative of a position of the object within the image in 2D image coordinates may comprise determining a position of a centre line of the object.

The centre line may generally correspond with the axis of rotation of the object. The position of the centre line may be determined based on the determination of the position of one or more outer edges of the object.

Determining data indicative of a position of the object in camera coordinates based on the data indicative of the position of the object within the image in 2D image coordinates and the data indicative of the length associated with the object may comprise: where the data indicative of the length associated with the object is data indicative of the physical dimension of the object, determining data indicative of a distance of the object from the camera that captured said image; or where the data indicative of the length associated with the object is data indicative of the distance of the object from one of the one or more cameras, determining data indicative of a radius of the object.

For example, the data indicative of the position of the object within the image in 2D image coordinates may comprises data indicating outer edges of the object, and data indicative of the physical dimension of the object may comprise data indicative of the radius of the object. From this information, a distance to the object can be determined using trigonometry. Alternatively, the radius can be determined from the data indicative of distance of the object from the camera that took the image and the data indicative of the position of the object within the image in 2D image coordinates using trigonometry.

Determining data indicative of a position of the object in camera coordinates based on the data indicative of the position of the object within the image in 2D image coordinates and the data indicative of the length associated with the object may comprise determining data indicative of an orientation of the object relative to the camera that captured said image.

For example, the tilt of the object or rotation of the objective relative to the camera can be determined. Here, tilt refers to orientation of the object in a y-z plane of the camera coordinates and rotation refers to orientation of the object in a x-y plane of the camera coordinates.

The method may further comprise intrinsically calibrating the one or more cameras to obtain the one or more intrinsic calibration parameters.

The method may further comprise obtaining a third image containing the object and at least a third portion of the mark, obtaining a fourth image containing the object and at least a fourth portion of the mark, wherein the at least third and fourth portions of the mark partially overlap, obtaining a third rectified image and fourth rectified image, stitching the first rectified image, the second rectified image, third rectified image and fourth rectified image to obtain the stitched image comprising the combined mark, the combined mark comprising the at least first, second, third and fourth portions of the mark.

Obtaining the rectified third image and rectified fourth image may comprise the steps for obtaining the rectified first image and rectified second image. The third image may be captured by a third camera and the fourth image may be captured by a fourth camera. Although, it will be appreciated that a single camera can be used that moves to different positions to take the third and fourth images.

Capturing the third image with the third camera may comprise arranging the third camera to capture the image from a third angle. Capturing the fourth image with the fourth camera may comprise arranging the fourth camera to capture the image from a fourth angle, the first, second, third and fourth angles being different from one another.

The arrangement of the first, second, third and fourth cameras may be such that an approximately 360 degree view of the object is obtained. For example, each of the cameras may be located at relative azimuth angles, 0 degrees, 90 degrees, 180 degrees, and 270 degrees, so as to effectively surround the object being imaged. Of course, if more images are obtained, the relative azimuth angle can be lower. For example, if six images are obtained, the relative azimuth angles may be separated by 60 degrees. Furthermore, while first, second, third and fourth cameras are described, it will be appreciated that in some implementations, fewer cameras are required, such as one camera, where the one camera captures multiple images of the object at different angles.

The object may comprise a cylindrical body, the mark extending about a portion of the cylindrical body.

For example, the object may be a receptacle for receiving a substance, such as a bottle. The mark may comprise information relating to the contents of the bottle. For example, the bottle may be for containing medicament, and the mark may comprise information relating to the medicament, such as batch number, date of manufacture, best before date, etc. The mark may comprise a barcode, QR code, or other machine readable code text, numbers, drawing, or symbols. The mark may have been printed onto the object, or may have been printed onto a substrate, such as a label, that is applied to the object.

Obtaining the 3D point cloud of the virtual object may comprise calculating the 3D point cloud based on the data indicative of the length associated with the object.

For example, using an obtained or calculated radius of the object, a number of discrete points of the point cloud can be calculated for the virtual object having said radius. The 3D point cloud may comprise a number of points located on a surface, such as a circumferential wall, of the virtual object.

Obtaining the 3D point cloud of the virtual object may comprise accessing a database containing a 3D point cloud for each of a plurality of virtual objects, and selecting the 3D point cloud of the virtual object corresponding to the object.

Each of the plurality of virtual objects may comprise virtual objects having different shapes and/or different dimensions, such as different radii. For example, a number of 3D point clouds for different objects may have been generated and stored in the database. Given an indication of a shape and/or physical dimension of the object, such as the radius of the object, the appropriate virtual object, and hence appropriate 3D point cloud, can be selected.

The method may further comprise illuminating the object with indirect light source when capturing one or more of the images.

Illuminating the object with indirect light source helps to provide homogenous lighting of the object, which improves the subsequent image processing steps, such as identifying the objects outer edges in the image and stitching images together.

The method may further comprise providing a homogenous background for any one of the images.

For example, a surface may be arranged on an opposite side of the object to the camera, said surface being arranged so as to provide a homogenous background. The surface may comprise a single colour. Providing a homogenous background may comprises determining a field of view of a camera, and arranging the surface in a region covering the field of view of the camera.

Providing a homogenous background may comprise locating the cameras in such a way that, when an image is taken of the object by a camera, the object obscures the view of at least one other camera.

The method may further comprise inspecting the combined mark.

Inspecting the combined mark may comprise determining data indicative of quality of the combined mark or reading a content of the combined mark.

For example, the quality may be a print quality, in either monochrome or colour. The quality may be used to give a visual feedback to the user about the look of the combined mark. Reading of the content may comprise reading the content of 1D or 2D bar codes (which appear in the combined mark) using automatic barcode reading methods. Reading may comprise reading the content of text strings (which appear in the combined mark) using automatic optical character recognition (OCR) methods.

In a second aspect of the invention there is provided a computed implemented method for stitching together a plurality of images, each image comprising a scene containing an object comprising a mark, the method comprising, obtaining intrinsic calibration parameters for one or more cameras, obtaining a first image captured by one of the one or more cameras, the first image containing the object and at least a first portion of a mark, obtaining a second image captured by one of the one or more cameras, the second image containing the object and at least a second portion of the mark, wherein the at least first and second portions of the mark partially overlap, and obtaining data indicative of a radius of the object. For each image the method further comprises determining data indicative of a position of the object within the image in 2D image coordinates, determining data indicative of a position of the object in camera coordinates based on the data indicative of the position of the object within the image in 2D image coordinates and the data indicative of the radius of the object, determining a transformation matrix based on the data indicative of the position of the object in camera coordinates, obtaining a 3D point cloud of a virtual object, said virtual object associated with the data indicative of the radius of the object, transforming the 3D point cloud of the virtual object using the transformation matrix to obtain a second 3D point cloud, projecting the second 3D point cloud into 2D image coordinates using the intrinsic calibration parameters to obtain a projected point grid, rectifying a portion of the image using the projected point grid to obtain a rectified image, stitching the first rectified image and the second rectified image to obtain a stitched image comprising a combined mark, the combined mark comprising the at least first and second portions of the mark.

In a third aspect of the invention there is provided a computed implemented method for stitching together a plurality of images, each image comprising a scene containing an object comprising a mark, the method comprising, obtaining intrinsic calibration parameters for one or more cameras, obtaining a first image captured by one of the one or more cameras, the first image containing the object and at least a first portion of a mark, obtaining a second image captured by one of the one or more cameras, the second image containing the object and at least a second portion of the mark, wherein the at least first and second portions of the mark partially overlap, and obtaining data indicative of a distance between the object and one of the one or more cameras. For each image, the method further comprises determining data indicative of a position of the object within the image in 2D image coordinates, determining data indicative of a radius of the object based on the data indicative of the position of the object within the image in 2D image coordinates and the data indicative of a distance between the object and one of the one or more cameras, determining data indicative of a position of the object in camera coordinates based on the data indicative of the position of the object within the image in 2D image coordinates and the data indicative of a distance between the object and one of the one or more cameras, determining a transformation matrix based on the data indicative of a position of the object in camera coordinates, obtaining a 3D point cloud of a virtual object, said virtual object associated with the data indicative of the radius of the object, transforming the 3D point cloud of the virtual object using the transformation matrix to obtain a second 3D point cloud, projecting the second 3D point cloud into 2D image coordinates using the intrinsic calibration parameters to obtain a projected point grid, rectifying a portion of the image using the projected point grid to obtain a rectified image, stitching the first rectified image and the second rectified image to obtain a stitched image comprising a combined mark, the combined mark comprising the at least first and second portions of the mark.

In a fourth aspect of the invention, there is provided an apparatus comprising an image capture zone configured to receive an object, one or more cameras configured to capture an image of the object within the image capture zone, and a processor configured to carry out the method of any method described herein.

The image capture zone may comprise a void. The image capture zone may be configured to extend over a transportation device, such as a conveyer. The object may travel along the transportation device, and though the image capture zone. The one or more cameras may be configured to capture images of the object when the object passes through the image capture zone.

In a fifth aspect of the invention there is provided a computer readable medium comprising computer readable instructions which, when executed by one or more processors, cause the one or more processors to carry out the method of any aspect described herein.

It will be appreciated that optional features of the first aspect may be combined with the second and third aspects where appropriate.

### BRIEF DESCRIPTION OF FIGURES

Examples of the disclosed subject matter are described below and with reference to the following figures, where:

FIG. 1 shows a schematic plan view of a bottle inspection device;

FIG. 2 shows a schematic side view of the bottle inspection device of FIG. 1;

FIG. 3 shows a schematic plan view of a camera and bottle in a camera coordinate system, showing, the X and Z axes and a line of sight to a centre of the bottle;

FIG. 4 shows relative dimensions of the bottle of FIG. 3, showing the distance between the bottle and the camera;

FIG. 5 shows a representation of a single point of a virtual point cloud of a virtual object;

FIG. 6 shows an image of a bottle having a mark, where outer edges and centre line of the bottle have been identified;

FIG. 7 shows the bottle of FIG. 6, where a 3D point cloud has been transformed to align with the bottle and has been projected into 2D image coordinates;

FIG. 8 shows a rectified image of the mark of FIG. 6; and

FIG. 9 is a flow diagram of a method of the disclosed subject matter.

### DETAILED DESCRIPTION

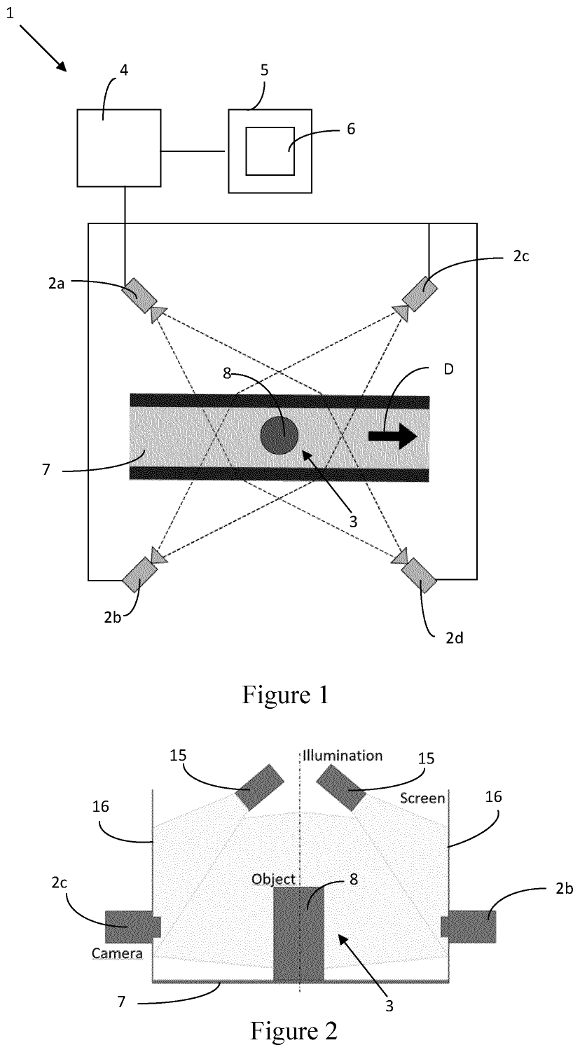

FIG. 1 shows a schematic plan view of a bottle inspection device 1. The bottle inspection device 1 comprises four cameras 2a, 2b, 2c, 2d for capturing images of a bottle 8. The four cameras 2a, 2b, 2c, 2d are arranged so as to provide 360 degree coverage of an image capture zone 3. That is, an azimuth angle between an optical axis of adjacent cameras may be approximately 90 degrees. Of course, with different numbers of cameras, other angles are possible. For example, if six cameras are used, the azimuth angle between an optical axis of adjacent cameras may be approximately 60 degrees. Additionally, in alternative arrangements, fewer cameras may be used, and less than 360 degree coverage of the image capture zone 3 may be provided. For example, in some implementations only approximately 180 degrees, or 270 degrees, coverage of the image capture zone 3 may be desired. The cameras 2a, 2b, 2c, 2d are generally located in a common plane, such as located at generally the same height (see FIG. 2). That is, the cameras 2a, 2b, 2c, 2d may capture an image of the bottle 8 in the image capture zone 3 at different angles so as to image different sides of the bottle 8, but where all images are taken at the same (or similar) height.

Each of the four cameras 2a, 2b, 2c, 2d is coupled to a processing device 4. Said coupling may be wired or wireless, using any appropriate method or protocol. The processing device 4 may comprise any suitable computer hardware, such as one or more processors and RAM, and may also comprise one or more I/O devices, such as keyboards, mice, displays, touch screens, microphones, speakers, etc. allowing user input. The processing device 4 is coupled to a memory 5, comprising one or more programs 6 for operating the processing device 4. The processing device 4 and/or memory 5 may be located in the local area of the cameras 2a, 2b, 2c, 2d (e.g. at the same packing, printing or production facility), or one or both may be located elsewhere, e.g. in the cloud.

The image capture zone 3 is arranged to cover a region of a conveyor 7 such that bottles (or any other object) travelling along the conveyor 7 pass through the image capture zone 3 as they travel along the conveyor 7 in direction D. A bottle 8 is shown in FIG. 1 in the image capture zone 3. As the bottle 8 passes through the image capture zone 3, each of the cameras 2a, 2b, 2c, 2d captures one or more images of the bottle 8. The cameras may be connected to a trigger (not shown) which triggers the cameras to capture one or more images. The trigger may be activated based on a location of the bottle 8. For example, as the bottle enters the image capture zone 3, or reaches a specific point in the image capture zone 3, the trigger may be activated causing the cameras 2a, 2b 2c, 2d to capture one or more images of the bottle. Any suitable triggering means may be used, such as sensors, timers, etc. The cameras 2a, 2b, 2c, 2d may be configured to capture an image of the bottle 8 simultaneously when triggered. In other examples, no triggering is used. For example, the cameras may continually take images whether or not a bottle 8 is located in the image capture zone 3 and the resulting images may be processed to determine if there is a bottle present in the image or not. In such cases, images may be correlated based on any suitable method, such as using timestamps or image numbering, etc.

Any suitable cameras may be used. For example, the cameras 2a, 2b, 2c, 2d may be area scan cameras. If the bottle 8 is in motion while being imaged, it is beneficial to use a global shutter on each camera. The cameras may be monochrome or colour cameras. Alternatively, the cameras may operate beyond the visible spectrum (such as the near infrared or ultraviolet).

As the cameras 2a, 2b, 2c, 2d are arranged 90 degrees apart, the captured images provide a 360 degree view of the bottle 8. Because each image from each camera shows different, but overlapping, perspectives of the bottle 8, it is necessary to stitch the images together to obtain a single, stitched image of the bottle 8. For example, each image may comprise different portions of a mark on the bottle 8, where the mark extends around a side wall of the bottle 8. Stitching the images together allows the entire mark to be reviewed in a single stitched image. The quality of the mark can then be determined by analysing the stitched image, and/or the information within the mark may be read. For example, a print quality of the mark may be determined. If the print quality is not adequate (e.g. falls below a threshold quality), remedial action can be taken.

It is advantageous to provide homogenous lighting and a homogenous background when capturing the images. This is to aid object detection in the image. FIG. 2 shows a schematic representation of a side view of the bottle inspection device 1. As can be seen, illumination elements 15 (such as lights) are provided which provide indirect light (e.g. the light is not directed directly onto the bottle 8), by being arranged to direct light onto a screen 16. The screen 16 may be a diffusively reflecting screen, providing a homogenous background. The screen 16 therefore acts as a light source to illuminate both the object and surrounding screens 16. In particular, the cameras 2a, 2b, 2c, 2d and screens 16 are arranged such that the screens 16 provide a background to the scene recorded by each camera 2a, 2b, 2c, 2d. The homogenous background therefore makes it easier to identify and segment the bottle 8 from the background in the image.

The screens 16 may of course have one or more apertures to allow light to travel to the cameras, where the cameras are installed behind the screen 16. Additionally, the cameras may be located in such a way that, when an image is taken of the bottle 8 by, for example, camera 2c, the bottle 8 obscures the view of the opposite camera, in this case camera 2b. This ensures that a first camera does not appear in the image taken by a second camera when the second camera is arranged opposite said first camera.

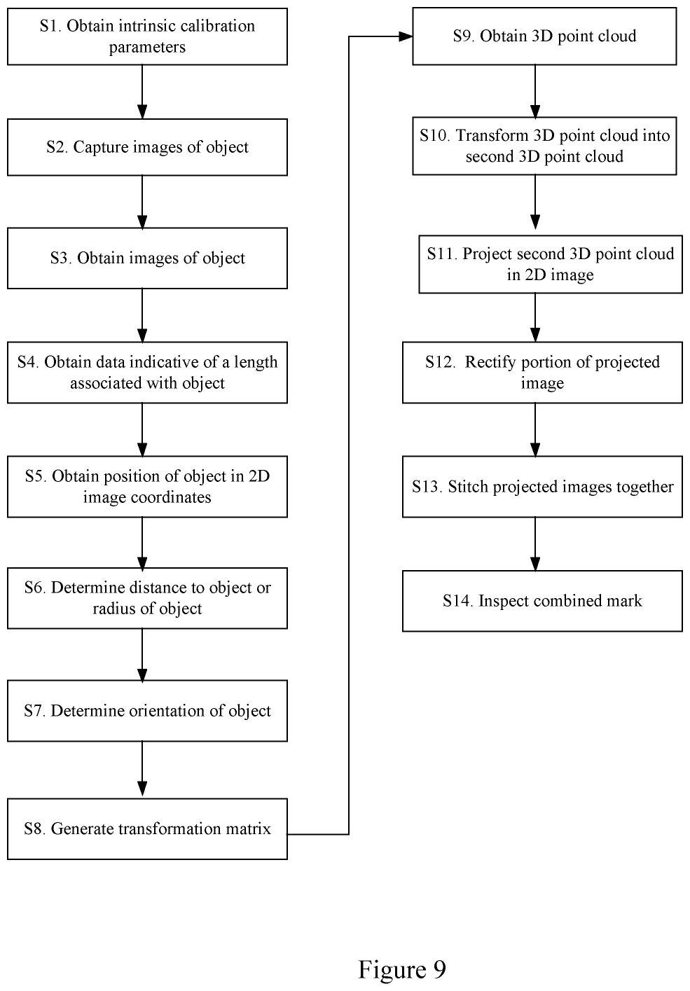

With reference to FIG. 9, there is now described a method according to the disclosed subject matter. The method may be carried out using the bottle inspection device 1.

At Step S1, intrinsic calibration parameters of the cameras 2a, 2b, 2c, 2d are obtained by the processing device 4. Using the example of FIG. 1, intrinsic calibration parameters are obtained for all four cameras 2a, 2b, 2c, 2d. Intrinsic calibration parameters may be obtained by carrying out intrinsic camera calibration on each camera 2a, 2b, 2c, 2d. Intrinsic calibration parameters reflect the internal properties of the camera. Such intrinsic calibration parameters may comprise the focal length, the principal point (or optical centre), the pixel size and/or a lens distortion parameter. While lens distortion parameter is described, it will be appreciated that other or additional distortion parameters are possible. The intrinsic calibration parameters can be used to determine a relationship between camera coordinates and image coordinates as will be known to the skilled person.

Intrinsic camera calibration can be carried out with a dataset of images taken by the camera of a calibration target (e.g. a target with a known pattern) as will be well known to the skilled person. Of course, intrinsic calibration parameters may also be provided by a manufacturer of the camera. However, obtaining generic intrinsic calibration parameters for a particular camera from a manufacturer is not as accurate as carrying out intrinsic calibration for the camera. This is because the camera manufacturing process often results in small irregularities between the physical components of each camera. As such, intrinsic calibration parameters, such as the focal length, may differ slightly between cameras of the same model. It is therefore advantageous to carry out intrinsic calibration for each camera.

When intrinsic calibration has been carried out for each camera 2a, 2b, 2c, 2d, or relevant intrinsic camera parameters are obtained elsewhere (such as from the manufacturer of the camera), a camera matrix K can be constructed, comprising the focal length, f, the pixel size, sₓ, s_{y}, and the optical centre cₓ, c_{y}:

$$K = ( \begin{matrix}\frac{f}{{s}_{x}} & 0 & {c}_{x} & 0 \\ 0 & \frac{f}{{s}_{y}} & {c}_{y} & 0 \\ 0 & 0 & 1 & 0\end{matrix} )$$

The focal length and the pixel size are typically expressed in millimetres, and the optical centre in pixels. The camera matrix K can be used to convert camera coordinates of an object into image coordinates.

Lens distortion is a transformation that can be modelled in the image plane alone. In the present example, the division model is used, which uses one parameter K to model radial distortions. Other models may be used, such as the polynomial model, which may contain a number of distortion coefficients, such as five. The parameter K models the magnitude of the radial distortions. If it is negative, the distortion is barrel-shaped, while for positive K the distortion is pincushion-shaped. The following equations can be used to transform distorted image plane coordinates (ũ,\tilde{v}) into undistorted image plane coordinates (u, v):

$$u = \frac{\tilde{u}}{1 + κ ( {\tilde{u}}^{2} + {\tilde{v}}^{2} )} and v = \frac{\tilde{v}}{1 + κ ( {\tilde{u}}^{2} + {\tilde{v}}^{2} )} .$$

At Step S2, each of the cameras 2a, 2b, 2c, 2d captures an image of the bottle 8. That is, each camera 2a, 2b, 2c, 2d captures an image of a scene containing the bottle 8. As described above, the cameras 2a, 2b, 2c, 2d capture the image when the bottle 8 is in the image capture zone 3. For example, the bottle 8 may be travelling along conveyor 7, where the path taken by the conveyor passes into and through the image capture zone 3. The cameras 2a, 2b, 2c, 2d are orientated so as to cover the full 360 degrees of the bottle 8, allowing all sides of the bottle 8 to be captured. As such, any mark, such as a label, applied to the side of the bottle is captured in two or more of the images.

For a mark that extends about all of, or a significant portion of, the circumferential side of the bottle, different, but overlapping, portions of the mark will be present in each of the images from each respective camera 2a, 2b, 2c, 2d. For example, four images may be obtained, where the first image contains the bottle 8 and at least a first portion of a mark, the second image contains the bottle 8 and at least a second portion of the mark, the third image contains the bottle 8 and at least a third portion of the mark, and the fourth image contains the bottle 8 and at least a fourth portion of the mark. The first, second, third and fourth portions of the mark may partially overlap with adjacent portions. For example, for a label that extends 360 degrees about the circumference of the side wall of the bottle 8, the first portion may partially overlap with the second portion and fourth portion, the second portion may partially overlap with the first portion and third portion, the third portion may partially overlap with the second portion and fourth portion, and the fourth portion may partially overlap with the third portion and the first portion.

At Step S3, the processing device 4 obtains the images. The processing device 4 may obtain the images directly from the cameras 2a, 2b, 2c, 2d or may obtain them from a storage device, where the images have been uploaded to said storage device.

At Step S4, data indicative of a length associated with the bottle 8 is obtained. For example, data indicative of a physical dimension of the bottle 8 is obtained by the processing device 4. The physical dimension may be any suitable physical dimension. In the following example, the physical dimension is the radius of the bottle 8. The processing device 4 may obtain the radius of the bottle 8 using any suitable means. For example, a user may input the radius of the bottle 8 into the processing device 4. That is, a user may have knowledge of the radius of the bottles that will be travelling along conveyor 7. The user may therefore input data indicating the radius into the processing device 4. Alternatively, one or more sensors may be used to automatically determine the radius of the bottle 8 as it is loaded onto, or travels along, the conveyor 7.

Alternatively, obtaining data indicative of a length associated with the bottle 8 may comprise determining a distance between the bottle 8 and camera that captured the image of the bottle. The distance may be determined using any suitable method such as being input by a user. The distance is representative of the distance between the camera that captured the image and the bottle 8.

For each image, the processing device 4 performs steps S5 to S12.

At Step S5, data indicative of a position of the bottle 8 within the image in 2D image coordinates (u, v) is determined by the processing device 4. In examples where lens distortion is taken into account, the obtained image may be considered to comprise a distorted image plane. As such, corrected 2D image coordinates (u, v) may be obtained by accounting for lens distortion, based on the parameter K, as described above.

In an example, the data indicative of a position of the bottle within the image may comprise data indicating one or more outer edges 8a, 8b of the bottle as seen in the image. The outer edges are identified in 2D image coordinates (u, v). FIG. 6 shows a captured image of a bottle 8, where the outer edges 8b, 8c have been identified. The outer edges 8b, 8c in this example correspond with the extent of the side walls of the bottle 8 as seen in the image. The outer edges 8b, 8c may be identified in the image using any suitable means. For example, the outer edges 8b, 8c may be identified based on a significant contrast change between the bottle 8 and a background of the image.

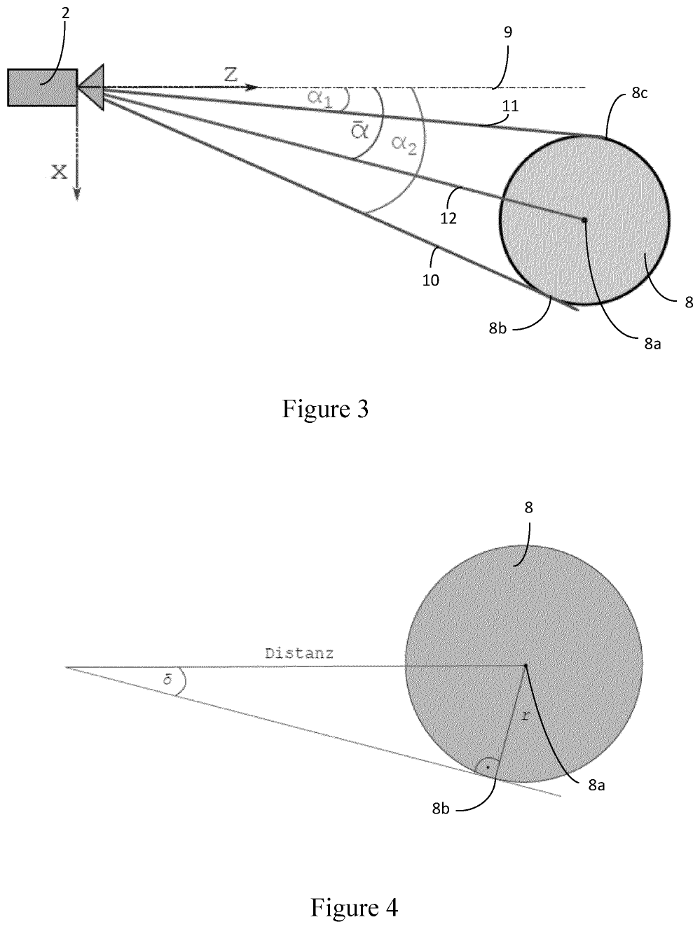

Further positional information relating to the bottle may be determined by the processing device 4. In this example, a centre line 8a of the bottle 8 is determined as shown in FIG. 6. The centre line 8a is first determined in 2D image coordinates (u, v). The centre line 8a corresponds with an axis of rotation of the bottle 8. The centre line 8a is determined based on the determination of the outer edges 8b, 8c of the bottle 8. For example, the mean distance between the two outer edges 8b, 8c may define the centre line 8a. However, in some cases, the centre line 8a does not necessarily lie in the middle of the two outer edges 8b, 8c due to perspective distortion, and/or the curvature of the bottle. For example, if the bottle 8 is no longer near the centre of the camera (e.g. off the optical axis 9 shown in FIG. 3), there will be deviations in the calculation of the centre line 8a due to the perspective. In this case the mean value of the outer edges 8a, 8c in the image deviates from the actual axis of rotation. It is therefore advantageous to calculate the angles α1, α2 between the optical axis 9 of the camera that took the image and the line of sight 10, 11 to each outer edge 8b, 8c using the intrinsic calibration parameters that were obtained for the camera that captured the image (see FIG. 3). The circular average α̅ of the two angles α1, α2 can then be determined which provides the angle α̅ of the line of sight 12 to the centre line 8a of the bottle 8.

At Step S6, either the distance between the camera 2 and the bottle 8 is determined by the processing device 4, or the radius of the bottle 8 is determined by the processing device 4. For example, where the radius is obtained at Step S4, the distance from the camera 2 to the bottle 8 is calculated based on the known radius r of the bottle, and at least one of the determined angles α1, α2 between the optical axis 9 and the line of sight 10, 11 to at least one of the outer edges 8b, 8c, and the angle α̅ between the optical axis 9 and the line of sight 12 to the centre line 8a. For example, the distance d can be calculated using:

$$d = \frac{r}{sin ( δ )}$$

Where the angle δ is the angle between α₂ and α̅ (although could alternatively be based on the angle between α̅ and α₁). With the distance d determined, the position of the bottle in camera coordinates (x, y, z) can be calculated using the angle α̅ between the optical axis 9 and the line of sight 12 to the centre line 8a as follows:

$${δ}_{x} = sin ( \overline{α} ) \cdot d$$

$${δ}_{z} = cos ( \overline{α} ) \cdot d$$

Where δₓ represent the position of the object in the x coordinates relative to the camera 2 and δ_{z} represent the position of the object in the z coordinates relative to the camera 2, where the origin is located at the camera, using the pinhole camera model. Note that the y coordinate, relating to height (or the vertical) in this example, has been omitted as this is not required. Of course, the y coordinates can be calculated if necessary.

In this example, distance d has been determined based on the angle δ (which is the angle between α₂ and α̅) and the radius r. It will be appreciated that if the distance d is obtained in step S4, then the radius can be calculated based on the angle δ and distance d. That is, in such cases, the radius does not need to be provided to the processing device 4.

At Step S7, the orientation of the bottle 8 is determined. The orientation comprises a rotation of the bottle and a tilt of the bottle relative to the camera. Here, tilt refers to orientation of the object in a Y-Z plane of the camera coordinates (e.g. the “tilt” of the object is defined as a rotation around the X-axis of the camera coordinate system) and rotation refers to orientation of the object in an X-Y plane of the camera coordinates (e.g. the “rotation” of the object is defined as a rotation around the Z-axis of the camera coordinate system).

The rotation is represented by angle β which is the angle between the centre line 8a and the vertical axis of the image (e.g. the v axis in 2D image coordinates). As will be well understood by the skilled person, the direction of a vector can be calculated from the arctangent of the quotient of the difference of the u-coordinates and the difference of the v-coordinates of two points of the vector. For example, β may be calculated using:

$$β = arctan \frac{{Q}_{u} - {P}_{u}}{{Q}_{v} - {P}_{v}}$$

Where Q and P are two points on centre line 8a, Qu, Pu are the u components of Q and P and Qv, Pv are the v components of Q and P.

The tilt of the bottle can be calculated from the identified two outer edges 8b, 8c in the image. For example, if the two outer edges converge or diverge in the image, the bottle 8 is tilted. The tilt angle γ in camera coordinates can be calculated from an angle φ₁ or φ₂ between one of the outer edges relative to the vertical axis of the image in 2D image coordinates. That is, φ₁ is the angle between one of the outer edges and the vertical in 2D image coordinates, and φ₂ is the angle between the other outer edge and the vertical in 2D image coordinates. The angle φ₁ and/or φ₂ can be calculated using trigonometry in the same way as the angle β of rotation (as described in Step S8). Typically, there is little deviation between φ₁ and φ₂ and in such cases, only one angle is required. However, for a more accurate results, a mean value φ̅ may be calculated as follows:

$$\overline{φ} = \frac{( β - {φ}_{1} ) + ( {φ}_{2} - β )}{2}$$

Having obtained φ̅, (or by using one of φ₁ or φ₂) the tilt of the bottle 8 may be calculated as:

$$γ = {tan}^{- 1} \vert ( \frac{{δ}_{z}}{r} \cdot tan \overline{φ} ) \vert$$

Where δ₂ is bottle's position along the Z-axis in camera coordinates and r is the bottle's radius.

At Step S8, a transformation matrix T_{cam} is generated by the processing device 4. The transformation matrix T_{cam} can be used to convert from one coordinate system to another. For example, the transformation matrix T_{cam} can be used to transfer a point in world coordinates to camera coordinates. The transformation matrix T_{cam} may comprise one or more matrices. In this example, T_{cam} comprises three matrices, Rᵣₒₜ, Rₜᵢₗₜ, Rₜᵣₐₙₛ, each describing rotation, tilt and translation respectively.

The rotation of the bottle can be described in a first rotation matrix Rᵣₒₜ with the rotation angle β, describing rotation around the Z-axis of the camera:

$${R}_{rot} = [ \begin{matrix}cos β & - sin β & 0 & 0 \\ sin β & cos β & 0 & 0 \\ 0 & 0 & 1 & 0 \\ 0 & 0 & 0 & 1\end{matrix} ]$$

The tilt of the object can be described in a second rotation matrix Rₜᵢₗₜ with the tilt angle γ, describing rotation around the X-axis of the camera:

$${R}_{tilt} = [ \begin{matrix}1 & 0 & 0 & 0 \\ 0 & cos γ & - sin γ & 0 \\ 0 & sin γ & cos γ & 0 \\ 0 & 0 & 0 & 1\end{matrix} ]$$

The position of the object can be described in a translation vector t with the position of the bottle δₓ and δ_{z}:

$$\vec{t} = ( \begin{matrix}{δ}_{x} \\ 0 \\ {δ}_{z} \\ 1\end{matrix} )$$

From the translation vector t, a translation matrix Rₜᵣₐₙₛ can be computed:

$${R}_{trans} = [ \begin{matrix}1 & 0 & 0 & {δ}_{x} \\ 0 & 1 & 0 & 0 \\ 0 & 0 & 1 & {δ}_{z} \\ 0 & 0 & 0 & 1\end{matrix} ]$$

The transformation matrix T_{cam} is then given by:

$${T}_{cam} = {R}_{rot} \cdot {R}_{tilt} \cdot {R}_{trans}$$

As noted above, in this example, T_{cam} comprises the three matrices, Rᵣₒₜ, Rₜᵢₗₜ, Rₜᵣₐₙₛ, each describing rotation, tilt and translation respectively. In other examples, T_{cam} may only comprise one or two of said matrices, depending on what transformations an end user needs to take into account. For example, depending on the set up of the apparatus (e.g. the cameras, conveyor, bottles, etc.), it may be that the either or both of the rotation angle or the tilt angle are about zero. In such case, either or both of Rᵣₒₜ and Rₜᵢₗₜ may be omitted from the calculation of T_{cam}.

At Step S9, a 3D point cloud of a virtual object is obtained by the processing device 4. The virtual object is associated with the physical object being imaged, e.g. the bottle 8. For example, the virtual object may have the same, or similar, shape to the bottle 8. In the present example, where the bottle 8 comprises a cylinder, the virtual object may be a virtual cylinder. The virtual object may have the same dimensions as the bottle 8, e.g. the same radius.

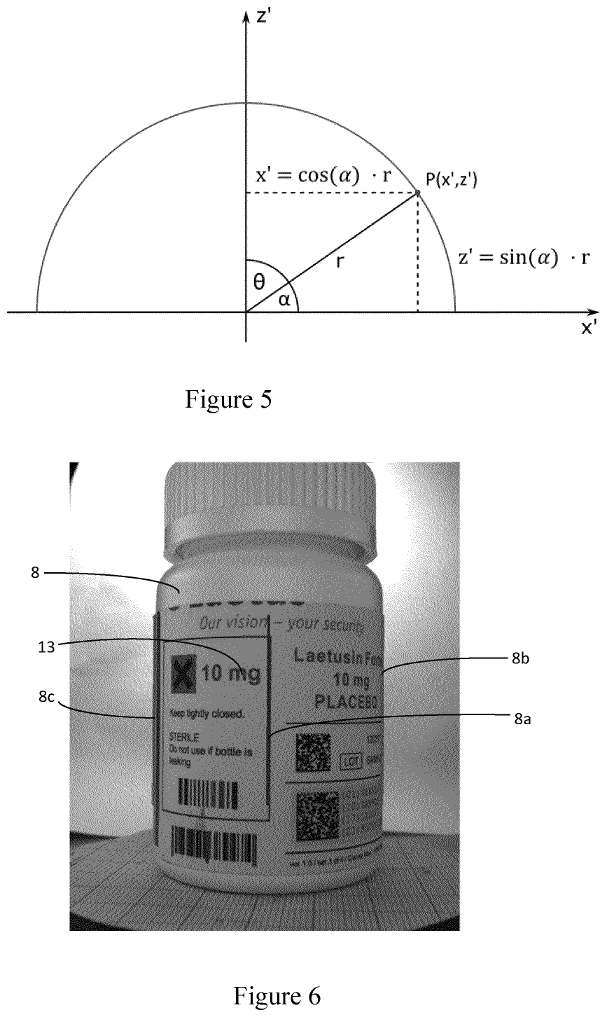

The 3D point cloud provides the position of a number of points P that correspond with the surface (e.g. circumferential wall) of the virtual object. The positions of the points P may be defined relative to a world coordinate system (x′, y′, z′). The origin of the world coordinate system may be arranged such that the origin is located along the axis of rotation of the bottle. The 3D point cloud may be calculated in real time by the processing device 4, or may be obtained, either from memory 5 or, for example, the cloud. The 3D point cloud may be calculated in any suitable way. For example, and with reference to FIG. 5, to calculate the virtual points in the world coordinate system the following formulas may be used:

$${P}_{x ′} = cos α \cdot r$$

$${P}_{z ′} = sin α \cdot r$$

Where P_{x′} is the x′ component of vector P(x′, z′), P_{z′} is the z′ component of the vector P(x′, z′), where P(x′, z) is located on an outer surface of the virtual object (e.g. defines a point on the outer surface of the virtual object), r is the radius of the virtual object, and α is the angle between the x′ axis and vector P(x′,z′). The radius of the virtual object corresponds with the radius of the bottle 8. For example, the radius of the virtual object can be set equal to the radius of the bottle 8, where the radius of the bottle 8 is either provided or calculated based on distance as described above.

In other examples, the 3D point cloud may be generated by imaging a test object having a shape corresponding to the bottle 8, where the relative dimensions of the test object are known. A 3D point cloud can then be generated that conforms to the relative dimensions of the test object.

Optionally, only the virtual 3D points for about one third (120°) of the cylindrical virtual object are obtained or generated. This is because each image only shows about 120° of the circumferential wall of the bottle 8, and so only about 120° are required.

At Step S10, the 3D point cloud is transformed by the processing device 4 using the transformation matrix to obtain a second 3D point cloud in camera coordinates. The second 3D point cloud may be considered to be a corrected 3D point cloud, in that the points of the 3D point cloud of the virtual object are corrected to map to the bottle 8 in the image in camera coordinates.

At Step S11, the second 3D point cloud is projected by the processing device 4 into 2D image coordinates to obtain a projected point grid. For example, the points of the second 3D point cloud are projected into 2D image coordinates. For example, given homogenous world coordinates (x′, y′ z′, 1) of the 3D point cloud, the transformation matrix T_{cam}, and the camera matrix K, the homogenous image coordinates may be obtained as follows:

$${( \begin{matrix}{u}_{h} \\ {v}_{h} \\ {w}_{h}\end{matrix} )}_{I} = K \cdot {T}_{cam} \cdot {( \begin{matrix}{x}^{′} \\ {y}^{′} \\ {z}^{′} \\ 1\end{matrix} )}_{W}$$

Where wₕ in the left hand vector represents the distance to the image plane on which uₕ and vₕ are located, as is well known by the skilled person. To obtain dehomogenised (inhomogeneous) image coordinates u, v, the values of uₕ and vₕ are each divided by wₕ:

$${( \begin{matrix}u \\ v \\ 1\end{matrix} )}_{I} = {( \begin{matrix}{u}_{h} / {w}_{h} \\ {v}_{h} / {w}_{h} \\ 1\end{matrix} )}_{I}$$

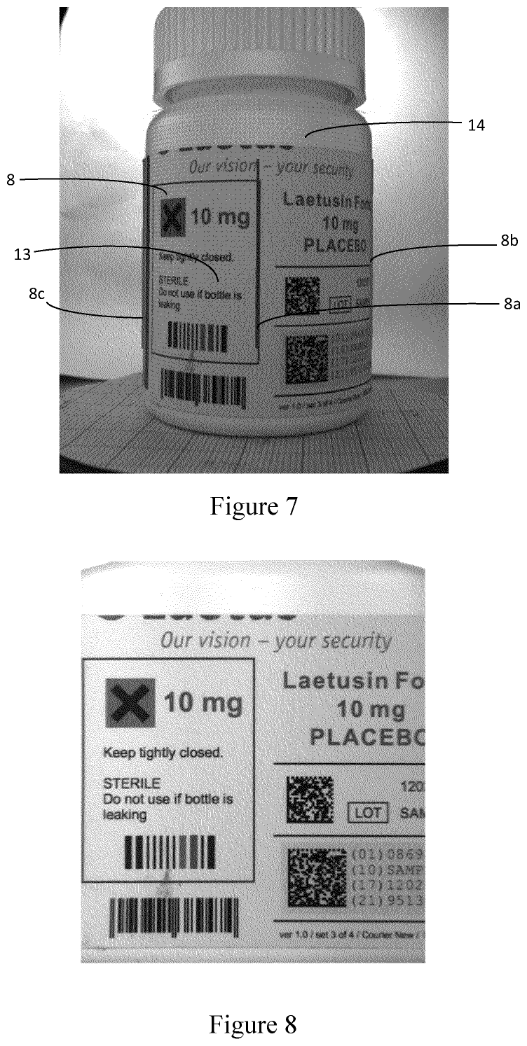

An example of said projected point grid is shown in FIG. 7, where the dots represent the 2D image coordinates of the projected point grid.

At Step S12, a portion of the image is rectified by the processing device 4. For example, a portion (or all of) the projected point grid is mapped onto a regular, undistorted, grid during rectification. The portion of the image that is rectified may comprise a portion of the mark, such as a portion of the label. An example of a rectified image comprising a rectified mark is shown in FIG. 8. As can be seen, the mark, in this example a label, is no longer distorted due to the curvature of the bottle 8.

At Step S13 the processing device 4 stiches together two or more of the images that have been processed according to steps S5 to S12, to obtain a stitched image. The stitched image may show a combined mark, the combined mark comprising a first portion of the mark from a first image and a second portion of the mark from a second image. The combined mark therefore may show a larger portion of the mark than is visible in each of the first and second image. For example, the combined mark may comprise a label in its entirety.

Stitching may be achieved using any suitable means. For example, corresponding feature points may be identified between images defining an overlap area of the images. Due to the relationship between the feature points, the images can be stitched together.

Once the stitched image has been generated, the stitched image may be used in a number of ways. For example, the combined mark may be inspected, such as read by the processing device 4. The inspection may comprise analysing the combined mark to determine data indicative of a quality of the combined mark. One or more actions may be taken based on the analysis of the mark. Alternatively or additionally, the data contained within the combined mark may be checked or recorded and stored in a database. For example, the data in the combined mark can be used to record which bottles that have passed through the bottle inspection device 1.

In Step S14, the combined mark is inspected. For example, inspection may comprises the processing device 4 determining data indicative of a quality of the combined mark. For example, the print quality of the combined mark may be determined. For example, the combined mark (corresponding to an actual print) may be compared against a reference print, and any deviations may be identified. For example grey value correlation may be used to identify deviations. If the print quality is not adequate, such as if the print quality falls below a specified threshold, action can be taken. For example, an alert may be provided to a user and/or corrective action may be taken.

In another example, inspection may comprise reading the mark. For example, OCR may be used to determine what is written in the mark, and/or object/symbol detection may be used to read symbols or codes in the mark. Once the mark is read, the information may be used in any suitable way, such as to record information relating to the bottles 8.

The method disclosed allows the quality of marks to be determined in real time as the bottles (or objects) are transported in a production, printing or packaging facility. Identified quality issues with a mark can be quickly identified and thus resolved with minimal disruption. In particular, each camera can be calibrated independently of any other camera, making it easier for cameras to be calibrated prior to installation at a user's facility.

While the processing of the method has been described as being carried out by the processing device 4, it will be appreciated that any processing device with a microprocessor may be used to carry out said processing. The processing device 4 may comprise a number of different processing devices. That is, the processing device may comprise a number of distributed processors in a processor network, where steps of the method may occur at different processors in the distributed processor network.

While various embodiments have been described herein, it will be appreciated that this description is in all respects illustrative, not restrictive. Various modifications will be apparent to the skilled person without departing from the spirit and scope of the invention.

1. A computed implemented method for stitching together a plurality of images, each image comprising a scene containing an object comprising a mark, the method comprising:
obtaining intrinsic calibration parameters for one or more cameras;
obtaining a first image captured by one of the one or more cameras, the first image containing the object and at least a first portion of a mark;
obtaining a second image captured by one of the one or more cameras, the second image containing the object and at least a second portion of the mark, wherein the at least first and second portions of the mark partially overlap;
obtaining data indicative of a length associated with the object; and
for each image:
determining data indicative of a position of the object within the image in 2D image coordinates;
determining data indicative of a position of the object in camera coordinates based on the data indicative of the position of the object within the image in 2D image coordinates and the data indicative of the length associated with the object;
determining a transformation matrix based on the data indicative of the position of the object in camera coordinates;
obtaining a 3D point cloud of a virtual object, said virtual object associated with the object;
transforming the 3D point cloud of the virtual object using the transformation matrix to obtain a second 3D point cloud;
projecting the second 3D point cloud into 2D image coordinates using the intrinsic calibration parameters to obtain a projected point grid;
rectifying a portion of the image using the projected point grid to obtain a rectified image; and
stitching the first rectified image and the second rectified image to obtain a stitched image comprising a combined mark, the combined mark comprising the at least first and second portions of the mark.

2. The method of claim 1, wherein obtaining data indicative of the length of the object comprises one of obtaining data indicative of a physical dimension of the object or obtaining data indicative of a distance of the object from one of the one or more cameras.

3. The method of claim 2, wherein obtaining data indicative of the physical dimension of the object comprises obtaining data indicative of a radius of the object.

4. The method of claim 1, wherein obtaining the first image comprises capturing the first image with one of the one or more cameras; and
obtaining the second image comprises capturing the second image with one of the one or more cameras.

5. The method of claim 4, wherein capturing the first image comprises
arranging one of the one or more cameras to capture the image from a first angle; and
capturing the second image comprises arranging one of the one or more cameras to capture the image from a second angle, the first angle different from the second angle.

6. The method of claim 1, wherein determining data indicative of a position of the object within the image in 2D image coordinates comprises determining a position of one or more outer edges of the object.

7. The method of claim 1, wherein determining data indicative of a position of the object within the image in 2D image coordinates comprises determining a position of a centre line of the object.

8. The method of claim 1, wherein determining data indicative of a position of the object in camera coordinates based on the data indicative of the position of the object within the image in 2D image coordinates and the data indicative of the length associated with the object comprises:
where the data indicative of the length associated with the object is data indicative of the physical dimension of the object, determining data indicative of a distance of the object from the camera that captured said image; or
where the data indicative of the length associated with the object is data indicative of the distance of the object from one of the one or more cameras, determining data indicative of a radius of the object.

9. The method of claim 1, wherein determining data indicative of a position of the object in camera coordinates based on the data indicative of the position of the object within the image in 2D image coordinates and the data indicative of the length associated with the object comprises:
determining data indicative of an orientation of the object relative to the camera that captured said image.

10. The method of claim 1, further comprising intrinsically calibrating the one or more cameras to obtain the one or more intrinsic calibration parameters.

11. The method of claim 1, further comprising
obtaining a third image containing the object and at least a third portion of the mark;
obtaining a fourth image containing the object and at least a fourth portion of the mark, wherein the at least third and fourth portions of the mark partially overlap;
obtaining a third rectified image and fourth rectified image;
stitching the first rectified image, the second rectified image, third rectified image and fourth rectified image to obtain the stitched image comprising the combined mark, the combined mark comprising the at least first, second, third and fourth portions of the mark.

12. The method of claim 1, wherein the object comprises a cylindrical body, the mark extending about a portion of the cylindrical body

13. The method of claim 1, wherein obtaining the 3D point cloud of the virtual object comprises calculating the 3D point cloud based on the data indicative of the length associated with the object.

14. The method of claim 1, wherein obtaining the 3D point cloud of the virtual object comprises accessing a database containing a 3D point cloud for each of a plurality of virtual objects, and selecting the 3D point cloud of the virtual object corresponding to the object.

15. The method of claim 1, when dependent on claim 4, further comprising illuminating the object with indirect light source when capturing one or more of the images.

16. The method of claim 1, further comprising providing a homogenous background for any one of the images.

17. The method of claim 1, further comprising inspecting the combined mark.

18. The method of claim 17, wherein inspecting the combined mark comprises determining data indicative of quality of the combined mark or reading a content of the combined mark.

19-20. (canceled)

21. An apparatus comprising:
an image capture zone configured to receive an object;
one or more cameras configured to capture an image of the object within the image capture zone;
a processor; and
a computer-readable medium having instructions thereon that are executable by the processor to cause the processor to,
obtain intrinsic calibration parameters for one or more cameras;
obtain a first image captured by one of the one or more cameras, the first image containing the object and at least a first portion of a mark;
obtain a second image captured by one of the one or more cameras, the second image containing the object and at least a second portion of the mark, wherein the at least first and second portions of the mark partially overlap;
obtain data indicative of a length associated with the object; and
for each image:
determine data indicative of a position of the object within the image in 2D image coordinates;
determine data indicative of a position of the object in camera coordinates based on the data indicative of the position of the object within the image in 2D image coordinates and the data indicative of the length associated with the object;
determine a transformation matrix based on the data indicative of the position of the object in camera coordinates;
obtain a 3D point cloud of a virtual object, said virtual object associated with the object;
transform the 3D point cloud of the virtual object using the transformation matrix to obtain a second 3D point cloud;
project the second 3D point cloud into 2D image coordinates using the intrinsic calibration parameters to obtain a projected point grid;
rectify a portion of the image using the projected point grid to obtain a rectified image; and
stitch the first rectified image and the second rectified image to obtain a stitched image comprising a combined mark, the combined mark comprising the at least first and second portions of the mark.

22. A non-transitory computer readable medium having instructions stored thereon that are executable by one or more processors, the instructions comprising:
instructions to obtain intrinsic calibration parameters for one or more cameras;
instructions to obtain a first image captured by one of the one or more cameras, the first image containing the object and at least a first portion of a mark;
instructions to obtain a second image captured by one of the one or more cameras, the second image containing the object and at least a second portion of the mark, wherein the at least first and second portions of the mark partially overlap;
instructions to obtain data indicative of a length associated with the object; and
for each image:
instructions to determine data indicative of a position of the object within the image in 2D image coordinates;
instructions to determine data indicative of a position of the object in camera coordinates based on the data indicative of the position of the object within the image in 2D image coordinates and the data indicative of the length associated with the object;
instructions to determine a transformation matrix based on the data indicative of the position of the object in camera coordinates;
instructions to obtain a 3D point cloud of a virtual object, said virtual object associated with the object;
instructions to transform the 3D point cloud of the virtual object using the transformation matrix to obtain a second 3D point cloud;
instructions to project the second 3D point cloud into 2D image coordinates using the intrinsic calibration parameters to obtain a projected point grid;
instructions to rectify a portion of the image using the projected point grid to obtain a rectified image; and
instructions to stitch the first rectified image and the second rectified image to obtain a stitched image comprising a combined mark, the combined mark comprising the at least first and second portions of the mark.
